(19) United States
(12) Patent Application Publication
(10) Pub. No.: US 2020/0173606 A1
(43) Pub. Date: Jun. 4, 2020

(54) Replaceable Fluid Container with Removable Manifold

(71) Applicant: Castrol Limited, Pangbourne, Reading (GB)

(72) Inventors: Rik Alewijnse, Essex (GB); Oliver Gilkes, Essex (GB); Oliver Paul Taylor, Reading (GB)

(21) Appl. No.: 16/628,020

(22) PCT Filed: Jul. 16, 2018
(86) PCT No.: PCT/EP2018/069320

§ 371 Date: Dec. 31, 2019

(30) Foreign Application Priority Data
Jul. 17, 2017 (GB) 1711486.9
Jul. 17, 2017 (GB) 1711488.5

(51) Int. Cl. F16N 19/00; F01M 11/04

(52) U.S. Cl. CPC F16N 19/00; F16N 37/00; F01M 11/0458

(57) ABSTRACT

A power unit replaceable fluid container, the power unit being in fluid connection with a fluid distribution system, is disclosed. The container comprises a generally cuboid housing adapted to contain a fluid, the housing having a continuous outer wall, a base portion closing one end of the outer wall and a lid portion situated opposite the base portion and closing a second end of the outer wall to form a container. An indent is provided in the base portion and a fluid inlet and a fluid outlet situated within the indent. The indent in the base portion is sized to receive and accommodate a removable manifold.

This invention relates a power unit replaceable fluid container, the power unit being in fluid connection with a fluid distribution system, and a removable manifold.

Various oil change systems are known, such as NEXCEL, available from Castrol Limited. These systems are compatible with both wet sump and dry sump engine systems. In a wet sump system, the engine retains a certain oil level within the sump during typical engine operation. After a period of use, normally defined either by time, vehicle mileage or engine operating history, this oil requires replacement. To do this the sump must be drained of the used oil and then charged with fresh oil, a process that requires manual removal of a sealing mechanism from the power unit, such as a plug, and waiting until all of the oil has been drained down from the sump. During use of the power unit, the level of oil may decrease due to minor leaks, breakdown of the chemical structure of the oil due to repeated heating cycles, loss to the combustion chamber and wear of engine components. Consequently, maintaining the level of oil within the power unit is critical to its optimum use.

An alternative engine set up is a dry-sump system where, rather than keeping oil within the power unit sump, clean oil and used oil are stored in remote oil tanks and pumped between the tank and the engine during use. Again, draining such systems is manually intensive and time-consuming, and the correct volume of oil must be available to be pumped into a power unit at all times.

Maintaining sufficient oil of the correct quality within a power unit can therefore be a challenging task. The oil itself can also be relatively costly, although smaller power units still consume several litres of oil both in use and in oil changes. Typically an oil change is carried out during a service by skilled personnel who have experience in the draining and charging both wet and dry sump systems. One further issue is that used oil is particularly hazardous and requires careful disposal to prevent any harm to persons carrying out the oil change or the environment. In addition to the oil change, it is often necessary to replace other ancillary components, such as oil filters and seals, at the same time as carrying out an oil change. It can be common to include oil filters within the oil container of an oil change system, such as NEXCEL above, so that when the oil container is replaced during servicing, the oil filter and seals are also replaced. Then, when the oil container is recycled, the oil filter can be removed, cleaned and/or replaced as required. However, this requires the disassembly of the whole oil container to access the oil filter. This can add time to the recycling process. It would be very helpful if at least some of these issues could be ameliorated.

Embodiments of the present invention address these issues by providing a power unit replaceable fluid container, the power unit being in fluid connection with a fluid distribution system, comprising: a generally cuboid housing adapted to contain a fluid, the housing having a continuous outer wall, a base portion closing one end of the outer wall and a lid portion situated opposite the base portion and closing a second end of the outer wall to form a container; an indent in the base portion; and a fluid inlet and a fluid outlet situated within the indent; wherein the indent in the base portion is sized to receive and accommodate a removable manifold.

In a second aspect, embodiments of the present invention also provide a removable manifold for use in a replaceable fluid container, comprising: a manifold housing having at least first and second opposing sides, a first opposing side adapted to be adjacent the replaceable fluid container and the second opposing side adapted to be remote from the fluid container; a manifold inlet and a manifold outlet positioned on the second opposing side; a container inlet and a container outlet positioned on the first opposing side; Wherein: interior to the manifold housing, the manifold inlet is connected to the container inlet and the manifold outlet is connected to the container outlet; and wherein a filter is mounted in the manifold housing such that fluid flowing into the manifold inlet and fluid flowing out of the manifold outlet flows via the filter; and wherein optionally the manifold encapsulates the filter membrane.

Embodiments of the invention will now be explained by way of example only and with reference to the accompanying drawings, in which:

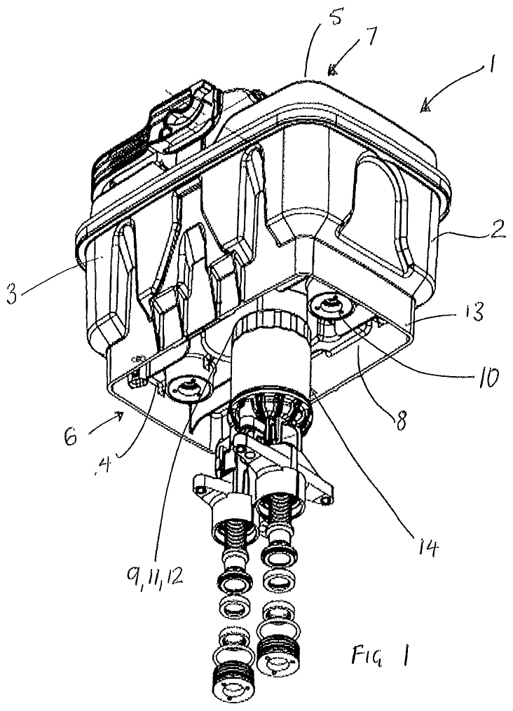

FIG. 1 is an exploded view of a replaceable fluid container with removable manifold in accordance with embodiments of the present invention; and

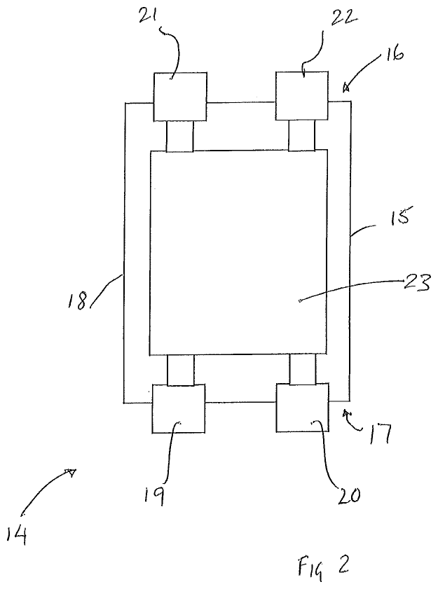

FIG. 2 is a schematic cross-section of a replaceable fluid container with removable manifold in accordance with embodiments of the present invention.

Embodiments of the present invention take the approach that a replaceable oil container can be used with a removable manifold that contains an oil filter. In situations where a power unit, such as an engine, is in fluid connection with a fluid distribution system, the replaceable fluid container comprises a generally cuboid housing adapted to contain a fluid, the housing having a continuous outer wall, a base portion closing one end of the outer wall and a lid portion situated opposite the base portion and closing a second end of the outer wall to form the container. An indent is provided in the base portion, with a fluid inlet and a fluid outlet situated within the indent. The indent itself is sized to receive and accommodate a removable manifold. The manifold comprises a manifold housing having at least first and second opposing sides. The first opposing side is adapted to be adjacent the replaceable fluid container and the second opposing side is adapted to be remote from the fluid container. A manifold inlet and a manifold outlet are positioned on the second opposing side. A container inlet and a container outlet are positioned on the first opposing side. Interior to the manifold housing, the manifold inlet is connected to the container inlet and the manifold outlet is connected to the container outlet. A filter is mounted in the manifold housing such that fluid flowing into the manifold inlet and fluid flowing out of the manifold outlet flows via the filter. This will now be described in more detail below.

FIG. 1 is an exploded view of a replaceable fluid container with removable manifold in accordance with embodiments of the present invention. The replaceable fluid container 1 comprises a housing 2 which is generally cuboid in shape. The housing 2 is adapted to contain a fluid, such as a lubricating oil, a coolant, hydraulic fluid or other fluid required for use with a power unit (not shown). Power units include engines (both two-stroke and four-stroke), motors (electric or otherwise) and power generation equipment. The housing 2 has a continuous outer wall 3, with a base portion 4 and a top portion 5. The base portion 4 closes a first end 6 of the outer wall 3, with the top portion 5 closing a second end 7 of the outer wall 3. This forms the replaceable fluid container 1. An indent 8 is provided in the base portion 4 along with an opening 9 that receives a transfer valve 10. The indent 8 contains a fluid inlet 11 and a fluid outlet 12 to enable fluid to flow into and out of the replaceable fluid container 1. The transfer valve is used to pump fluid out of the replaceable fluid container 1 into the power unit itself (in a wet sump system) or a further replaceable fluid container 1a (including a container having two separated halves) (in a dry sump system). The base portion 4 is further adapted to sit within a dock (not shown) provided to connect the replaceable fluid container 1 with a fluid distribution system of the power unit. To do this the base portion 4 also comprises a small upstand 13 running around the periphery of the base portion 4 that aids in guiding and retaining the replaceable fluid container 1 in the dock.

A removable manifold 14 may be connected to the replaceable fluid container 1 via the indent 8 in order for fluid contained in the replaceable fluid container 1 to flow out through the manifold 14. The manifold 14 may be connected using a friction fit, where the indent 8 and manifold 14 are sized such that the manifold 14 just fits into the indent 8 and is retained by friction. Alternatively, the indent 8 in the base portion 4 may include securing means (not shown) to secure the removable manifold 14 to the housing 2. The securing means may comprise a screw thread or at least one lip and channel arrangement. For example, a single lip may extend around the entire periphery of the indent 8 or several smaller lips may be provided regularly spaced around the periphery of the indent 8. The indent 8 itself is sized to receive and accommodate a removable manifold 14. Additionally or alternatively, the removable manifold 14 may comprise a self-sealing coupling.

As shown in FIG. 2, the manifold 14 comprises a manifold housing 15 that has at least first 16 and second 17 opposing sides. The first opposing side 16 is adapted to be adjacent the replaceable fluid container 1 and the second opposing side 17 adapted to be remote from the replaceable fluid container 1. A continuous wall 18 separates the two. A manifold inlet 19 and a manifold outlet 20 are positioned on the second opposing side 17, and a container inlet 21 and a container outlet 22 are positioned on the first opposing side 16. The container inlet 21 is adapted to connect in fluid connection to the fluid inlet 1 land the container outlet 22 is adapted to connect is fluid connection to the fluid outlet 12. Interior to the manifold housing 15, the manifold inlet 19 is connected to the container inlet 21 and the manifold outlet 19 is connected to the container outlet 22. This through connection enables fluid to flow out of the replaceable fluid container 1 via the manifold 14. A filter 23is mounted in the manifold housing 15 such that fluid flowing into the manifold inlet 19 and fluid flowing out of the manifold 20 outlet flows via the filter. The manifold 14 further comprises a screw thread or at least one channel and lip to engage with the securing means in the indent of the base portion 5. For example, in the case of a screw thread, an equal and opposite thread or retention means are located on the manifold 14 to those on the indent 8. In the case of the channel and lip arrangement, each channel provided on the inlet 8 has a corresponding lip on the manifold 14, and each lip on the inlet 8 has a corresponding channel on the manifold itself. Alternatively other means such as securing clips can be used to retain the manifold 14 in the inlet 8. By using the removable manifold arrangement, during servicing when the replaceable fluid container 1 is removed, the manifold can also be removed and cleaned separately. Since there is no need to break open the replaceable fluid container 1 to remove the filter this design offers advantages over those known in the art.

The replaceable fluid container 1 is preferable made from recyclable and/or reusable materials. These include many plastics materials and reinforced plastics materials, such as nylon, that may be recycled easily or are robust enough to be reused several times. With this in mind, the replaceable manifold 14 is adapted to be removed from the housing 2 to facilitate the recycling and/or reuse of the replaceable fluid container 1. The replaceable manifold 14 may also be made from a recyclable material, preferably the same as, or compatible with, the material used for the replaceable fluid container 1. The replaceable fluid container 1 may also comprise a controller unit to control the flow of fluid into and out of the replaceable fluid container 1. The controller may comprise a processor and a memory to store information about the fluid, fluid flow or fluid quality. The controller may be able to communicate with an engine controller in the machine 1. The replaceable fluid container 1 also comprises a level sensor to indicate when the fluid within the replaceable fluid container has reached a critical level. The push-fit connectors are made of suitable materials such as stainless steel.

Further embodiments of the present invention will be apparent to the person skilled in the art from the scope of the dependent claims.

1. Power unit replaceable fluid container, the power unit being in fluid connection with a fluid distribution system, comprising:
A generally cuboid housing adapted to contain a fluid, the housing having a continuous outer wall, a base portion closing one end of the outer wall and a lid portion situated opposite the base portion and closing a second end of the outer wall to form a container;
An indent in the base portion; and
A fluid inlet and a fluid outlet situated within the indent;
Wherein the indent in the base portion is sized to receive and accommodate a removable manifold.

2. Replaceable fluid container as claimed in claim 1, wherein
The indent in the base portion includes securing means to secure the removable manifold to the housing.

3. Replaceable fluid container as claimed in claim 2, wherein
The securing means comprise a screw thread or at least one lip and channel arrangement.

4. Replaceable fluid container as claimed in claim 1, wherein the base portion is further adapted to sit within a dock provided to connect the replaceable fluid container with the fluid distribution system of the power unit.

5. Removable manifold for use in the replaceable fluid container as claimed in claim 1, comprising:
A manifold housing having at least first and second opposing sides, a first opposing side adapted to be adjacent the replaceable fluid container and the second opposing side adapted to be remote from the fluid container;
A manifold inlet and a manifold outlet positioned on the second opposing side;
A container inlet and a container outlet positioned on the first opposing side;
Wherein interior to the manifold housing, the manifold inlet is connected to the container inlet and the manifold outlet is connected to the container outlet; and
Wherein a filter is mounted in the manifold housing such that fluid flowing into the manifold inlet and fluid flowing out of the manifold outlet flows via the filter.

6. Removable manifold as claimed in claim 5, further comprising a screw thread or at least one channel and lip to engage with the securing means in the indent of the base portion.

7. Replaceable fluid container as claimed in any preceding claim 1, wherein the fluid is a lubricating fluid.

8. Removable manifold as claimed in claim 5, further comprising a self-sealing coupling.
